(19) United States
(12) Patent Application Publication
(10) Pub. No.: US 2014/0303882 A1
(43) Pub. Date: Oct. 9, 2014

(54) APPARATUS AND METHOD FOR PROVIDING INTERSECTION COLLISION-RELATED INFORMATION

(71) Applicant: Electronics and Telecommunications Research Institute, Daejeon (KR)

(72) Inventors: Jeong-Ah JANG, Daejeon (KR); Sang-Heon PARK, Seoul (KR); Hyun-Jeong YUN, Daejeon (KR); Dong-Yong KWAK, Daejeon (KR)

(73) Assignee: Electronics and Telecommunications Research Institute, Daejeon (KR)

(21) Appl. No.: 14/146,226

(22) Filed: Jan. 2, 2014

(30) Foreign Application Priority Data
Apr. 5, 2013 (KR) 10-2013-0037583

(51) Int. Cl. G08G 1/16

(52) U.S. Cl. CPC G08G 1/166
USPC 701/119

(57) ABSTRACT

Disclosed herein are an apparatus and method for providing intersection collision-related information. The apparatus for providing intersection collision-related information includes a surrounding information acquisition unit, a collision-related information calculation unit, and a collision-related information provision unit. The surrounding information acquisition unit acquires intersection traffic information including vehicle heading information, vehicle turning frequency information, vehicle trajectory information and vehicle speed information from one or more of a road sensor provided at an intersection and a vehicle sensor provided in a vehicle. The collision-related information calculation unit calculates intersection collision-related information including the degree of vehicle collision risk that is calculated using the intersection traffic information. The collision-related information provision unit provides the calculated intersection collision-related information to a user.

### CROSS REFERENCE TO RELATED APPLICATION

This application claims priority to and the benefit of Korean Patent Application No. 10-2013-0037583, filed on Apr. 5, 2013, which is hereby incorporated by reference in its entirety into this application.

### BACKGROUND OF THE INVENTION

1. Technical Field

The present invention relates generally to an apparatus and method for providing intersection collision-related information and, more particularly, to an apparatus and method for providing intersection collision-related information, which are capable of acquiring intersection traffic information using a road sensor provided at an intersection and a vehicle sensor provided in a vehicle, calculating intersection collision-related information using the intersection traffic information, and providing the intersection collision-related information to a user.

2. Description of the Related Art

Recently, with the popularization of intelligent transport systems (ITSs) including car navigation systems and telematics, a road monitoring service that both an administrator and a driver can use has rapidly attracted attention.

Korean Patent Application Publication No. 2011-0097091 discloses an intersection collision avoidance apparatus and method for an autonomous vehicle, which is capable of issuing a warning to a user using information about a counterpart vehicle that will pass through an intersection.

In addition, Korean Patent Application Publication No. 2011-0094986 discloses a collision avoidance system and method using the wall-penetration radar of a vehicle, which is capable of, in order to avoid a collision with another vehicle that is hidden by a building, calculating the location of the other vehicle and the probability of colliding with the vehicle and providing the results of the calculation to a user.

These conventional collision-related information provision technologies for the avoidance of collisions merely calculate collision-related information using only information about a counterpart vehicle that will pass through an intersection or information about another vehicle that is hidden by a building. Accordingly, those conventional collision-related information provision technologies have no provision for technology that probabilistically calculates a vehicle turning direction using vehicle heading information and vehicle turning frequency information before a vehicle turns at an intersection, calculates intersection collision-related information using the vehicle turning direction, and provides the intersection collision-related information, thereby enabling the provision of intersection collision-related information capable of allowing a user to become aware of the degree of risk in advance before the user passes through the intersection.

As a result, there is an urgent need for new intersection collision-related information provision technology that, in order to allow a user to pass through an intersection more safely, acquires intersection traffic information using a road sensor provided at an intersection and a vehicle sensor provided in a vehicle, probabilistically calculates a vehicle turning direction in advance before a vehicle turns at an intersection using vehicle heading information and vehicle turning frequency information, selects predicted collision points using contacts between vehicle trajectories, determines whether each of the predicted collision points is a highly risky point, and calculates a vehicle collision probability using a collision probability function, thereby enabling a user to become aware of the degree of risk in advance before passing through the intersection, to become clearly aware of points to which the user should pay attention while passing through the intersection, and to become more clearly aware of the degree of risk while passing through the intersection.

### SUMMARY OF THE INVENTION

The present invention is intended to provide an apparatus and method for providing intersection collision-related information, which acquire intersection traffic information using a road sensor provided at an intersection and a vehicle sensor provided in a vehicle, calculate intersection collision-related information using the intersection traffic information, and provide the intersection collision-related information to a user, thereby enabling the provision of intersection collision-related information that is capable of allowing a user to pass through the intersection more safely.

Furthermore, the present invention is intended to provide an apparatus and method for providing intersection collision-related information, which probabilistically calculate a vehicle turning direction using vehicle heading information and vehicle turning frequency information in advance before a vehicle turns at an intersection, calculate intersection collision-related information using the vehicle turning direction, and provide the intersection collision-related information, thereby enabling the provision of intersection collision-related information that is capable of allowing a user to become aware of the degree of risk in advance before the user passes through the intersection.

Furthermore, the present invention is intended to provide an apparatus and method for providing intersection collision-related information, which select predicted collision points using contacts between vehicle trajectories, determine whether each of the predicted collision points is a highly risky point, and provide the results of the determination to a user, thereby enabling the provision of intersection collision-related information that is capable of allowing a user to become clearly aware of points to which the user should pay attention while passing through the intersection.

Moreover, the present invention is intended to provide an apparatus and method for providing intersection collision-related information, which calculate a vehicle collision probability using a collision probability function, thereby enabling the provision of intersection collision-related information that is capable of allowing a user to become more clearly aware of the degree of risk while passing through the intersection.

In accordance with an aspect of the present invention, there is provided an apparatus for providing intersection collision-related information, including a surrounding information acquisition unit configured to acquire intersection traffic information including vehicle heading information, vehicle turning frequency information, vehicle trajectory information and vehicle speed information from one or more of a road sensor provided at an intersection and a vehicle sensor provided in a vehicle; a collision-related information calculation unit configured to calculate intersection collision-related information including a degree of vehicle collision risk that is calculated using the intersection traffic information; and a collision-related information provision unit configured to provide the calculated intersection collision-related information to a user.

The collision-related information calculation unit may include a turning probability calculation unit configured to calculate a vehicle turning probability using the vehicle heading information and the vehicle turning frequency information; a collision probability calculation unit configured to calculate a vehicle collision probability using the vehicle trajectory and the vehicle speed information; and a degree-of-collision risk calculation unit configured to calculate the degree of vehicle collision risk using the vehicle turning probability and the vehicle collision probability.

The collision probability calculation unit may select predicted collision points using contacts between vehicle trajectories, may calculate arrival time to each of the predicted collision points using the vehicle speed information, and may calculate the vehicle collision probability using the arrival time and a collision probability function.

The collision probability function may be a function in which arrival difference time, that is, an absolute value of the difference between the arrival time of the first vehicle to each of the predicted collision points and the arrival time of the second vehicle to the predicted collision point, is a function variable and the vehicle collision probability corresponding to the arrival difference time is a function result value.

The degree-of-collision risk calculation unit may calculate a value obtained by adding products of the vehicle turning probability and the vehicle collision probability at the predicted collision points as the degree of vehicle collision risk.

The vehicle heading information may be right heading coordinates and left heading coordinates that belong to the corner coordinates of the vehicle and that are two sets of coordinate values in a heading direction of the vehicle.

The turning probability calculation unit may calculate a vehicle turning direction using time rates of change of the right heading coordinates and the left heading coordinate, and may calculate the vehicle turning probability using the vehicle turning direction and the vehicle turning frequency information.

The vehicle trajectory information may be information about a trajectory that is set by taking into consideration one or more of a number of access roads to the intersection, and a number of lanes and a breadth of lanes for each access road.

The collision-related information provision unit may provide the intersection collision-related information corresponding to a vehicle in which the user rides in real time

The collision-related information provision unit may provide highly risky point information and highly risky time span information at the intersection using the intersection collision-related information corresponding to each of the vehicles that enter the intersection.

In accordance with another aspect of the present invention, there is provided a method of providing intersection collision-related information, including acquiring intersection traffic information including vehicle heading information, vehicle turning frequency information, vehicle trajectory information and vehicle speed information from one or more of a road sensor provided at an intersection and a vehicle sensor provided in a vehicle; calculating intersection collision-related information including a degree of vehicle collision risk that is calculated using the intersection traffic information; and providing the calculated intersection collision-related information to a user.

Calculating the intersection collision-related information may include calculating a vehicle turning probability using the vehicle heading information and the vehicle turning frequency information; calculating a vehicle collision probability using the vehicle trajectory and the vehicle speed information; and calculating the degree of vehicle collision risk using the vehicle turning probability and the vehicle collision probability.

Calculating the intersection collision-related information may include selecting predicted collision points using contacts between vehicle trajectories; calculating arrival time to each of the predicted collision points using the vehicle speed information; and calculating the vehicle collision probability using the arrival time and a collision probability function.

The collision probability function may be a function in which arrival difference time, that is, an absolute value of the difference between the arrival time of the first vehicle to each of the predicted collision points and the arrival time of the second vehicle to the predicted collision point, is a function variable and the vehicle collision probability corresponding to the arrival difference time is a function result value.

Calculating the degree of vehicle collision risk may include calculating a value obtained by adding products of the vehicle turning probability and the vehicle collision probability at the predicted collision points as the degree of vehicle collision risk.

The vehicle heading information may be right heading coordinates and left heading coordinates that belong to the corner coordinates of the vehicle and that are two sets of coordinate values in a heading direction of the vehicle.

Calculating the vehicle turning probability may include calculating a vehicle turning direction using time rates of change of the right heading coordinates and the left heading coordinate, and calculating the vehicle turning probability using the vehicle turning direction and the vehicle turning frequency information.

The vehicle trajectory information may be information about a trajectory that is set by taking into consideration one or more of a number of access roads to the intersection, and a number of lanes and a breadth of lanes for each access road.

Providing the calculated intersection collision-related information may include providing the intersection collision-related information corresponding to a vehicle in which the user rides in real time

Providing the calculated intersection collision-related information may include providing highly risky point information and highly risky time span information at the intersection using the intersection collision-related information corresponding to each of the vehicles that enter the intersection.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram apparatus for providing intersection collision-related information according to an embodiment of the present invention;

FIG. 2 is a block diagram illustrating an example of the collision-related information calculation unit illustrated in FIG. 1;

FIG. 3 is an operation flowchart illustrating a method of providing intersection collision-related information according to an embodiment of the present invention;

FIG. 4 is a diagram illustrating an example of selecting predicted collision points using the collision probability calculation unit of the present invention;

FIG. 5 is a diagram illustrating an example of a collision probability function according to the present invention;

FIG. 6 is a diagram illustrating an example of a collision matrix according to the present invention; and

FIG. 7 is a diagram illustrating an example of vehicle heading information according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

Embodiments of the present invention will be described in detail with reference to the accompanying drawings.

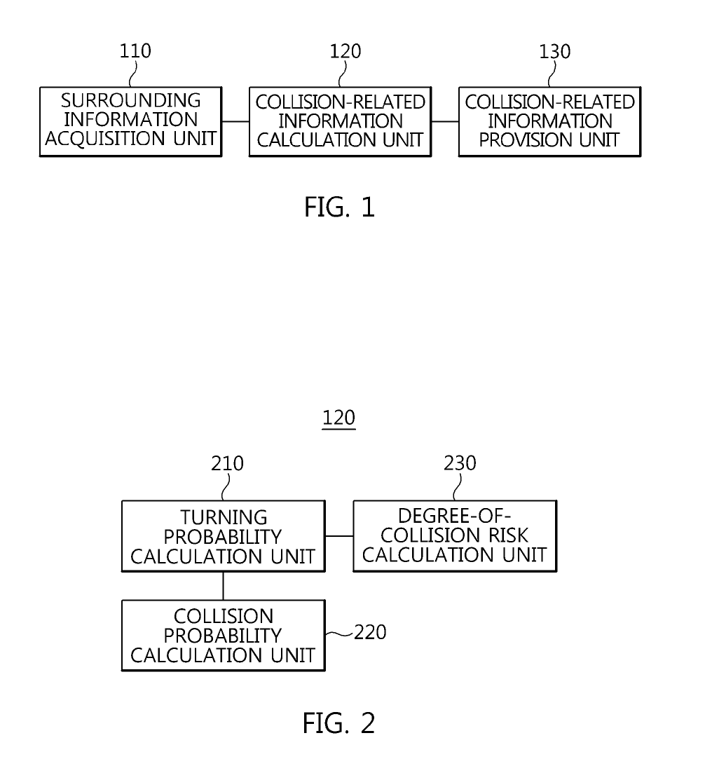

FIG. 1 is a block diagram apparatus for providing intersection collision-related information according to an embodiment of the present invention.

Referring to FIG. 1, the apparatus for providing intersection collision-related information according to an embodiment of the present invention includes a surrounding information acquisition unit 110, a collision-related information calculation unit 120, and a collision-related information provision unit 130.

The surrounding information acquisition unit 110 acquires intersection traffic information including vehicle heading information, vehicle turning frequency information, vehicle trajectory information and vehicle speed information from one or more of a road sensor provided at an intersection and a vehicle sensor provided in a vehicle.

In this case, the vehicle heading information may include right heading coordinates and left heading coordinates that belong to the corner coordinates of the vehicle and that are two sets of coordinate values in the heading direction of the vehicle.

In this case, the corner coordinates may be absolute coordinates based on an Earth coordinate system or local coordinates based on a local area including the intersection.

In this case, the vehicle turning frequency information may include the numbers of straight moves, right turns and left turns of vehicles in each traffic lane per preset unit time.

In this case, the vehicle trajectory information may be information about a trajectory that is set by taking into consideration one or more of the number of access roads to the intersection, and the number of lanes and the breadth of lanes for each access road.

For example, if the number of access roads to the intersection is 3, a corresponding intersection may be referred to as a three-way intersection. In the same manner, if the number of access roads to the intersection is 4, a corresponding intersection may be referred to as a four-way intersection. Furthermore, if the number of access roads to the intersection is 5, a corresponding intersection may be referred to as a five-way intersection.

For example, if the number of lanes for each access road is 2, a corresponding road is referred to as a two-lane road. In the same manner, if the number of lanes for each access road is 3, a corresponding road is referred to as a three-lane road. Furthermore, if the number of lanes for each access road is 4, a corresponding road is referred to as a four-lane road.

For example, the breadth of a lane may be in the range from 3 to 3.5 m.

The collision-related information calculation unit 120 calculates intersection collision-related information including the degree of vehicle collision risk that is calculated using the intersection traffic information.

In this case, the collision-related information calculation unit 120 may include a turning probability calculation unit 210 configured to calculate a vehicle turning probability using the vehicle heading information and the vehicle turning frequency information; a collision probability calculation unit 220 configured to calculate a vehicle collision probability using the vehicle trajectory and the vehicle speed information; and a degree-of-collision risk calculation unit 230 configured to calculate the degree of vehicle collision risk using the vehicle turning probability and the vehicle collision probability.

In this case, the turning probability calculation unit 210 may calculate a vehicle turning direction using the time rate of change in the right heading coordinates and the time rate of change in the left heading coordinates, and may calculate the vehicle turning probability using the vehicle turning direction and the vehicle turning frequency information.

In this case, the turning probability calculation unit 210 may determine that the vehicle turning direction corresponds to a straight move if the rate of change in turning difference, that is, the difference between the time rate of change in the right heading coordinates and the time rate of change in the left heading coordinates, is lower than a preset reference straight moving value.

In this case, the turning probability calculation unit 210 may determine that the vehicle turning direction corresponds to a right turn if the rate of change in turning difference is equal to or higher than the preset reference straight moving value and the time rate of change in the right heading coordinates is larger than the time rate of change in the left heading coordinates.

In this case, the turning probability calculation unit 210 may determine that the vehicle turning direction corresponds to a left turn if the rate of change in turning difference is equal to or higher than the preset reference straight moving value and the time rate of change in the left heading coordinates is higher than the time rate of change in the right heading coordinates.

In this case, the vehicle turning probability may include a straight move probability, a right turn probability, and a left turn probability.

In this case, the straight move probability may be a vehicle turning probability that is calculated such that a first straight move probability in the case where the rate of change in turning difference, that is, the difference between the time rate of change in the right heading coordinates and the time rate of change in the left heading coordinates, is the first rate of change in turning difference, is lower than a second straight move probability in the case where the rate of change in turning difference is the second rate of change in turning difference that is lower than the first rate of change in turning difference.

In this case, the right turn probability may be a vehicle turning probability that is calculated such that when the time rate of change in the right heading coordinates is higher than the time rate of change in the left heading coordinates, a first right turn probability in the case where the rate of change in turning difference is the first rate of change in turning difference is higher than a second right turn probability in the case where the rate of change in turning difference is the second rate of change in turning difference that is lower than the first rate of change in turning difference.

In this case, the right turn probability may be a vehicle turning probability that is calculated such that when the time rate of change in the left heading coordinates is higher than the time rate of change in the right heading coordinates, a first right turn probability in the case where the rate of change in turning difference is the first rate of change in turning difference is a second right turn probability in the case where the rate of change in turning difference is the second rate of change in turning difference that is lower than the first rate of change in turning difference.

In this case, the left turn probability may be a vehicle turning probability that is calculated such that when the time rate of change in the left heading coordinates is higher than the time rate of change in the right heading coordinates, a first left turn probability in the case where the rate of change in turning difference is the first rate of change in turning difference is higher than a second left turn probability in the case where the rate of change in turning difference is the second rate of change in turning difference that is lower than the first rate of change in turning difference.

In this case, the left turn probability may be a vehicle turning probability that is calculated such that when the time rate of change in the right heading coordinates is higher than the time rate of change in the left heading coordinates, a first left turn probability in the case where the rate of change in turning difference is the first rate of change in turning difference is a second left turn probability in the case where the rate of change in turning difference is the second rate of change in turning difference that is lower than the first rate of change in turning difference.

In this case, the turning probability calculation unit 210 may calculate the vehicle turning probability using any one of a Markov chain technique and a Bayesian technique.

In this case, the collision probability calculation unit 220 may select predicted collision points using contacts between vehicle trajectories, may calculate arrival time to each of the predicted collision points using the vehicle speed information, and may calculate the vehicle collision probability using the arrival time and a collision probability function.

In this case, the collision probability calculation unit 220 may select the predicted collision points using a collision matrix indicating whether there are trajectory overlaps between the vehicle trajectories of a first vehicle that enters a first access road and the vehicle trajectories of a second vehicle that enters a second access road.

For example, the collision probability calculation unit 220 may select the predicted collision points using the collision matrix indicating that when, at a four-way intersection, the access road of the first vehicle is oriented in a southward direction and the access road of the second vehicle is oriented in an eastward direction, there is a trajectory overlap in the case where the first vehicle travels straight ahead and the second vehicle travels straight ahead, there is a trajectory overlap in the case where the first vehicle travels straight ahead and the second vehicle turns right, there is a trajectory overlap in the case where the first vehicle travels straight ahead and the second vehicle turns left, there is no trajectory overlap in the case where the first vehicle turns right and the second vehicle travels straight ahead, there is no trajectory overlap in the case where the first vehicle turns right and the second vehicle turns right, there is almost no trajectory overlap in the case where the first vehicle turns right and the second vehicle turns left, there is a trajectory overlap in the case where the first vehicle turns left and the second vehicle travels straight ahead, there is almost no trajectory overlap in the case where the first vehicle turns left and the second vehicle turns right, and there is a trajectory overlap in the case where the first vehicle turns left and the second vehicle turns left.

In this case, the collision matrix may include a number of matrices equal to the number of access roads.

For example, if the number of access roads is 3, the collision matrix may include a first matrix indicating whether there is a trajectory overlap between the vehicle trajectories of a first vehicle that enters a first access road and the vehicle trajectories of a second vehicle that enters a second access road, a second matrix indicating whether there is a trajectory overlap between the vehicle trajectories of the first vehicle that enters the first access road and the vehicle trajectories of a third vehicle that enters a third access road, and a third matrix indicating whether there is a trajectory overlap between the vehicle trajectories of the second vehicle that enters the second access road and the vehicle trajectories of the third vehicle that enters the third access road.

In this case, the collision probability function is a function in which arrival difference time, that is, the absolute value of the difference between the arrival time of the first vehicle to each of the predicted collision points and the arrival time of the second vehicle to the predicted collision point, is a function variable and the vehicle collision probability corresponding to the arrival difference time is a function result value.

For example, the collision probability function may be a function in which the vehicle collision probability is 100% in the range from an arrival difference time of 0 to a first difference time 510, the vehicle collision probability gradually decreases in the range from the first difference time 510 to a second difference time 520, and the vehicle collision probability is 0% in the range from the second difference time 520.

In this case, the collision probability function in the range from the first difference time 510 to the second difference time 520 may be a function in which a third vehicle collision probability in the case where the arrival difference time is the third difference time 530 is equal to or higher than a fourth vehicle collision probability in the case where the arrival difference time is a fourth difference time 540 that is longer than the third difference time 530.

In this case, the collision probability function may be a function that is set by taking into consideration one or more of the type of vehicle, the speed of a vehicle, and the number of lanes.

In this case, the degree-of-collision risk calculation unit 230 may calculate a value obtained by adding the products of the vehicle turning probability and the vehicle collision probability at the predicted collision points as the degree of vehicle collision risk.

The collision-related information provision unit 130 provides the calculated intersection collision-related information to the user.

In this case, the collision-related information provision unit 130 may provide the intersection collision-related information corresponding to a vehicle in which the user rides in real time.

In this case, the collision-related information provision unit 130 may provide the access road direction information of the vehicle in which the user rides and another vehicle that enters an access road different from the access road of the former vehicle.

In this case, the collision-related information provision unit 130 may provide the degree of vehicle collision risk between the vehicle in which the user rides and the other vehicle that enters an access road that is different from the access road of the former vehicle in real time.

In this case, the collision-related information provision unit 130 may provide highly risky point information and highly risky time span information at the intersection using the intersection collision-related information corresponding to each of the vehicles that enter the intersection.

In this case, the collision-related information provision unit 130 may provide the time average value of the degree of vehicle collision risk corresponding to each of the vehicles that enter the intersection.

FIG. 2 is a block diagram illustrating an example of the collision-related information calculation unit 120 illustrated in FIG. 1.

Referring to FIG. 2, the collision-related information calculation unit 120 illustrated in FIG. 1 includes a turning probability calculation unit 210, a collision probability calculation unit 220, and a degree-of-collision risk calculation unit 230.

The turning probability calculation unit 210 calculates a vehicle turning probability using the vehicle heading information and the vehicle turning frequency information.

In this case, the turning probability calculation unit 210 may calculate a vehicle turning direction using the time rate of change in the right heading coordinates and the time rate of change in the left heading coordinates, and may calculate the vehicle turning probability using the vehicle turning direction and the vehicle turning frequency information.

In this case, the turning probability calculation unit 210 may determine that the vehicle turning direction corresponds to a straight move if the rate of change in turning difference, that is, the difference between the time rate of change in the right heading coordinates and the time rate of change in the left heading coordinates, is lower than a preset reference straight moving value.

In this case, the turning probability calculation unit 210 may determine that the vehicle turning direction corresponds to a right turn if the rate of change in turning difference is higher than the preset reference straight moving value and the time rate of change in the right heading coordinates is higher than the time rate of change in the left heading coordinates.

In this case, the turning probability calculation unit 210 may determine that the vehicle turning direction corresponds to a left turn if the rate of change in turning difference is equal to or higher than the preset reference straight moving value and the time rate of change in the left heading coordinates is higher than the time rate of change in the right heading coordinates.

In this case, the vehicle turning probability may include a straight move probability, a right turn probability, and a left turn probability.

In this case, the straight move probability may be a vehicle turning probability that is calculated such that a first straight move probability in the case where the rate of change in turning difference, that is, the difference between the time rate of change in the right heading coordinates and the time rate of change in the left heading coordinates, is the first rate of change in turning difference, is lower than a second straight move probability in the case where the rate of change in turning difference is the second rate of change in turning difference that is lower than the first rate of change in turning difference.

In this case, the right turn probability may be a vehicle turning probability that is calculated such that when the time rate of change in the right heading coordinates is higher than the time rate of change in the left heading coordinates, a first right turn probability in the case where the rate of change in turning difference is the first rate of change in turning difference is higher than a second right turn probability in the case where the rate of change in turning difference is the second rate of change in turning difference that is lower than the first rate of change in turning difference.

In this case, the right turn probability may be a vehicle turning probability that is calculated such that when the time rate of change in the left heading coordinates is higher than the time rate of change in the right heading coordinates, a first right turn probability in the case where the rate of change in turning difference is the first rate of change in turning difference is a second right turn probability in the case where the rate of change in turning difference is the second rate of change in turning difference that is lower than the first rate of change in turning difference.

In this case, the left turn probability may be a vehicle turning probability that is calculated such that when the time rate of change in the left heading coordinates is higher than the time rate of change in the right heading coordinates, a first left turn probability in the case where the rate of change in turning difference is the first rate of change in turning difference is higher than a second left turn probability in the case where the rate of change in turning difference is the second rate of change in turning difference that is lower than the first rate of change in turning difference.

In this case, the left turn probability may be a vehicle turning probability that is calculated such that when the time rate of change in the right heading coordinates is higher than the time rate of change in the left heading coordinates, a first left turn probability in the case where the rate of change in turning difference is the first rate of change in turning difference is a second left turn probability in the case where the rate of change in turning difference is the second rate of change in turning difference that is lower than the first rate of change in turning difference.

In this case, the turning probability calculation unit 210 may calculate the vehicle turning probability using any one of a Markov chain technique and a Bayesian technique.

The collision probability calculation unit 220 may calculate a vehicle collision probability using the vehicle trajectory and the vehicle speed information.

In this case, the collision probability calculation unit 220 may select predicted collision points using contacts between vehicle trajectories, may calculate arrival time to each of the predicted collision points using the vehicle speed information, and may calculate the vehicle collision probability using the arrival time and a collision probability function.

In this case, the collision probability calculation unit 220 may select the predicted collision points using a collision matrix indicating whether there are trajectory overlaps between the vehicle trajectories of a first vehicle that enters a first access road and the vehicle trajectories of a second vehicle that enters a second access road.

For example, the collision probability calculation unit 220 may select the predicted collision points using the collision matrix indicating that when, at a four-way intersection, the access road of the first vehicle is oriented in a southward direction and the access road of the second vehicle is oriented in an eastward direction, there is a trajectory overlap in the case where the first vehicle travels straight ahead and the second vehicle travels straight ahead, there is a trajectory overlap in the case where the first vehicle travels straight ahead and the second vehicle turns right, there is a trajectory overlap in the case where the first vehicle travels straight ahead and the second vehicle turns left, there is no trajectory overlap in the case where the first vehicle turns right and the second vehicle travels straight ahead, there is no trajectory overlap in the case where the first vehicle turns right and the second vehicle turns right, there is almost no trajectory overlap in the case where the first vehicle turns right and the second vehicle turns left, there is a trajectory overlap in the case where the first vehicle turns left and the second vehicle travels straight ahead, there is almost no trajectory overlap in the case where the first vehicle turns left and the second vehicle turns right, and there is a trajectory overlap in the case where the first vehicle turns left and the second vehicle turns left.

In this case, the collision matrix may include a number of matrices equal to the number of access roads.

For example, if the number of access roads is 3, the collision matrix may include a first matrix indicating whether there is a trajectory overlap between the vehicle trajectories of a first vehicle that enters a first access road and the vehicle trajectories of a second vehicle that enters a second access road, a second matrix indicating whether there is a trajectory overlap between the vehicle trajectories of the first vehicle that enters the first access road and the vehicle trajectories of a third vehicle that enters a third access road, and a third matrix indicating whether there is a trajectory overlap between the vehicle trajectories of the second vehicle that enters the second access road and the vehicle trajectories of the third vehicle that enters the third access road.

In this case, the collision probability function is a function in which arrival difference time, that is, the absolute value of the difference between the arrival time of the first vehicle to each of the predicted collision points and the arrival time of the second vehicle to the predicted collision point, is a function variable and the vehicle collision probability corresponding to the arrival difference time is a function result value.

For example, the collision probability function may be a function in which a first vehicle collision probability in the case where the arrival difference time is the first difference time 510 is equal to or higher than a second vehicle collision probability in the case where the arrival difference time is the second difference time 520 that is longer than the first difference time 510.

In this case, the collision probability function may be a function that is set by taking into consideration one or more of the type of vehicle, the speed of the vehicle, and the number of lanes.

The degree-of-collision risk calculation unit 230 calculates the degree of vehicle collision risk using the vehicle turning probability and the vehicle collision probability.

In this case, the degree-of-collision risk calculation unit 230 may calculate a value obtained by adding the products of the vehicle turning probability and the vehicle collision probability at the predicted collision points as the degree of vehicle collision risk.

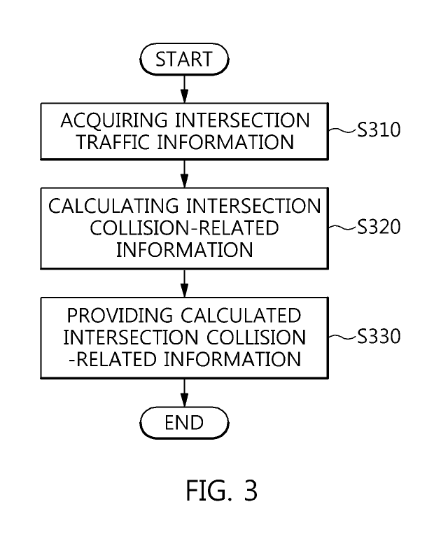

FIG. 3 is an operation flowchart illustrating a method of providing intersection collision-related information according to an embodiment of the present invention.

Referring to FIG. 3, in the method of providing intersection collision-related information according to this embodiment of the present invention, intersection traffic information including vehicle heading information, vehicle turning frequency information, vehicle trajectory information and vehicle speed information is acquired from one or more of a road sensor provided at an intersection and a vehicle sensor provided in a vehicle at step S310.

In this case, the vehicle heading information may include right heading coordinates and left heading coordinates that belong to the corner coordinates of the vehicle and that are two sets of coordinate values in the heading direction of the vehicle.

In this case, the corner coordinates may be absolute coordinates based on an Earth coordinate system or local coordinates based on a local area including the intersection.

In this case, the vehicle turning frequency information may include the numbers of straight moves, right turns and left turns of vehicles in each traffic lane per preset unit time.

In this case, the vehicle trajectory information may be information about a trajectory that is set by taking into consideration one or more of the number of access roads to the intersection, and the number of lanes and the breadth of lanes for each access road.

For example, if the number of access roads to the intersection is 3, a corresponding intersection may be referred to as a three-way intersection. In the same manner, if the number of access roads to the intersection is 4, a corresponding intersection may be referred to as a four-way intersection. Furthermore, if the number of access roads to the intersection is 5, a corresponding intersection may be referred to as a five-way intersection.

For example, if the number of lanes for each access road is 2, a corresponding road is referred to as a two-lane road. In the same manner, if the number of lanes for each access road is 3, a corresponding road is referred to as a three-lane road. Furthermore, if the number of lanes for each access road is 4, a corresponding road is referred to as a four-lane road.

For example, the breadth of a lane may be in the range from 3 to 3.5 m.

In the method of providing intersection collision-related information according to this embodiment of the present invention, intersection collision-related information including the degree of vehicle collision risk that is calculated is calculated using the intersection traffic information at step S320.

In this case, step S320 may include the step of calculating a vehicle turning probability using the vehicle heading information and the vehicle turning frequency information; the step of calculating a vehicle collision probability using the vehicle trajectory and the vehicle speed information; and the step of calculating the degree of vehicle collision risk using the vehicle turning probability and the vehicle collision probability.

In this case, the step of calculating a vehicle turning probability may include the step of calculating a vehicle turning direction using the time rates of change of the right heading coordinates and the left heading coordinate, and the step of calculating the vehicle turning probability using the vehicle turning direction and the vehicle turning frequency information.

In this case, the step of calculating a vehicle turning probability may determine that the vehicle turning direction corresponds to a straight move if the rate of change in turning difference, that is, the difference between the time rate of change in the right heading coordinates and the time rate of change in the left heading coordinates is lower than a preset reference straight moving value.

In this case, the step of calculating a vehicle turning probability may determine that the vehicle turning direction corresponds to a right turn if the rate of change in turning difference is equal to or higher than the preset reference straight moving value and the time rate of change in the right heading coordinates is larger than the time rate of change in the left heading coordinates.

In this case, the step of calculating a vehicle turning probability may determine that the vehicle turning direction corresponds to a left turn if the rate of change in turning difference is equal to or higher than the preset reference straight moving value and the time rate of change in the left heading coordinates is higher than the time rate of change in the right heading coordinates.

In this case, the vehicle turning probability may include a straight move probability, a right turn probability, and a left turn probability.

In this case, the straight move probability may be a vehicle turning probability that is calculated such that a first straight move probability in the case where the rate of change in turning difference, that is, the difference between the time rate of change in the right heading coordinates and the time rate of change in the left heading coordinates, is the first rate of change in turning difference, is lower than a second straight move probability in the case where the rate of change in turning difference is the second rate of change in turning difference that is lower than the first rate of change in turning difference.

In this case, the right turn probability may be a vehicle turning probability that is calculated such that when the time rate of change in the right heading coordinates is higher than the time rate of change in the left heading coordinates, a first right turn probability in the case where the rate of change in turning difference is the first rate of change in turning difference is higher than a second right turn probability in the case where the rate of change in turning difference is the second rate of change in turning difference that is lower than the first rate of change in turning difference.

In this case, the right turn probability may be a vehicle turning probability that is calculated such that when the time rate of change in the left heading coordinates is higher than the time rate of change in the right heading coordinates, a first right turn probability in the case where the rate of change in turning difference is the first rate of change in turning difference is a second right turn probability in the case where the rate of change in turning difference is the second rate of change in turning difference that is lower than the first rate of change in turning difference.

In this case, the left turn probability may be a vehicle turning probability that is calculated such that when the time rate of change in the left heading coordinates is higher than the time rate of change in the right heading coordinates, a first left turn probability in the case where the rate of change in turning difference is the first rate of change in turning difference is higher than a second left turn probability in the case where the rate of change in turning difference is the second rate of change in turning difference that is lower than the first rate of change in turning difference.

In this case, the left turn probability may be a vehicle turning probability that is calculated such that when the time rate of change in the right heading coordinates is higher than the time rate of change in the left heading coordinates, a first left turn probability in the case where the rate of change in turning difference is the first rate of change in turning difference is a second left turn probability in the case where the rate of change in turning difference is the second rate of change in turning difference that is lower than the first rate of change in turning difference.

In this case, the step of calculating a vehicle turning probability may calculate the vehicle turning probability using any one of a Markov chain technique and a Bayesian technique.

In this case, the step of calculating a vehicle collision probability may include the steps of selecting predicted collision points using contacts between vehicle trajectories, calculating arrival time to each of the predicted collision points using the vehicle speed information, and calculating the vehicle collision probability using the arrival time and a collision probability function.

In this case, the step of calculating a vehicle collision probability may include the step of selecting the predicted collision points using a collision matrix indicating whether there are trajectory overlaps between the vehicle trajectories of a first vehicle that enters a first access road and the vehicle trajectories of a second vehicle that enters a second access road.

For example, the step of calculating a vehicle collision probability may include the step of selecting the predicted collision points using the collision matrix indicating that when, at a four-way intersection, the access road of the first vehicle is oriented in a southward direction and the access road of the second vehicle is oriented in an eastward direction, there is a trajectory overlap in the case where the first vehicle travels straight ahead and the second vehicle travels straight ahead, there is a trajectory overlap in the case where the first vehicle travels straight ahead and the second vehicle turns right, there is a trajectory overlap in the case where the first vehicle travels straight ahead and the second vehicle turns left, there is no trajectory overlap in the case where the first vehicle turns right and the second vehicle travels straight ahead, there is no trajectory overlap in the case where the first vehicle turns right and the second vehicle turns right, there is almost no trajectory overlap in the case where the first vehicle turns right and the second vehicle turns left, there is a trajectory overlap in the case where the first vehicle turns left and the second vehicle travels straight ahead, there is almost no trajectory overlap in the case where the first vehicle turns left and the second vehicle turns right, and there is a trajectory overlap in the case where the first vehicle turns left and the second vehicle turns left.

In this case, the collision matrix may include a number of matrices equal to the number of access roads.

For example, if the number of access roads is 3, the collision matrix may include a first matrix indicating whether there is a trajectory overlap between the vehicle trajectories of a first vehicle that enters a first access road and the vehicle trajectories of a second vehicle that enters a second access road, a second matrix indicating whether there is a trajectory overlap between the vehicle trajectories of the first vehicle that enters the first access road and the vehicle trajectories of a third vehicle that enters a third access road, and a third matrix indicating whether there is a trajectory overlap between the vehicle trajectories of the second vehicle that enters the second access road and the vehicle trajectories of the third vehicle that enters the third access road.

In this case, the collision probability function is a function in which arrival difference time, that is, the absolute value of the difference between the arrival time of the first vehicle to each of the predicted collision points and the arrival time of the second vehicle to the predicted collision point, is a function variable and the vehicle collision probability corresponding to the arrival difference time is a function result value.

For example, the collision probability function may be a function in which the vehicle collision probability is 100% in the range from an arrival difference time of 0 to a first difference time 510, the vehicle collision probability gradually decreases in the range from the first difference time 510 to a second difference time 520, and the vehicle collision probability is 0% in the range from the second difference time 520.

In this case, the collision probability function in the range from the first difference time 510 to the second difference time 520 may be a function in which a third vehicle collision probability in the case where the arrival difference time is the third difference time 530 is equal to or higher than a fourth vehicle collision probability in the case where the arrival difference time is a fourth difference time 540 longer than the third difference time 530.

In this case, the collision probability function may be a function that is set by taking into consideration one or more of the type of vehicle, the speed of the vehicle, and the number of lanes.

In this case, the step of calculating the degree of collision risk may include the step of calculating a value obtained by adding the products of the vehicle turning probability and the vehicle collision probability at the predicted collision points as the degree of vehicle collision risk.

Furthermore, the method of providing collision-related information provides the calculated intersection collision-related information to the user at step S330.

In this case, step S330 may provide the intersection collision-related information corresponding to a vehicle in which the user rides in real time.

In this case, step S330 may provide the access road direction information of the vehicle in which the user rides and another vehicle that enters an access road different from the access road of the former vehicle.

In this case, step S330 may provide the degree of vehicle collision risk between the vehicle in which the user rides and another vehicle that enters an access road different from the access road of the former vehicle in real time.

In this case, step S330 may provide highly risky point information and highly risky time span information at the intersection using the intersection collision-related information corresponding to each of the vehicles that enter the intersection.

In this case, step S330 may provide the time average value of the degree of vehicle collision risk corresponding to each of the vehicles that enter the intersection.

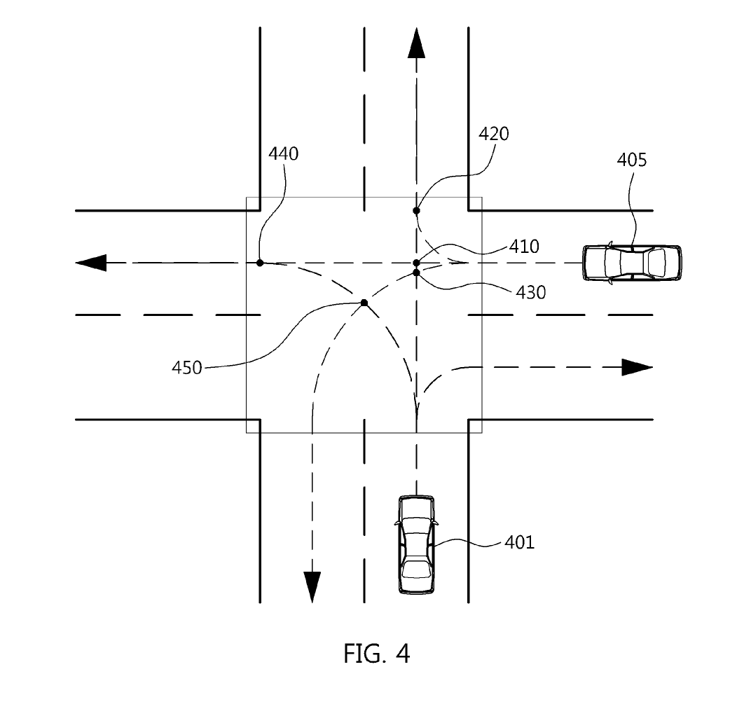

FIG. 4 is a diagram illustrating an example of selecting predicted collision points using the collision probability calculation unit 220 of the present invention.

Referring to FIG. 4, the collision probability calculation unit 220 of the present invention may select predicted collision points using contacts between the vehicle trajectories.

In this case, the collision probability calculation unit 220 may select the predicted collision points using contacts between the vehicle trajectories of the first vehicle 401 that enters the first access road and the vehicle trajectories road of the second vehicle 405 that enters the second access.

For example, in the case where at a four-way intersection, the access road of a first vehicle is oriented in a southward direction and the access road of a second vehicle is oriented in an eastward direction, the collision probability calculation unit 220 may select a first contact 410 in the case where the first vehicle travels straight ahead and the second vehicle travels straight ahead, a second contact 420 in the case where the first vehicle travels straight ahead and the second vehicle turns right, a third contact 430 in the case where the first vehicle travels straight ahead and the second vehicle turns left, a fourth contact 440 in the case where the first vehicle turns left and the second vehicle travels straight ahead, and a fifth contact 450 in the case where the first vehicle turns left and the second vehicle turns left as the predicted collision points.

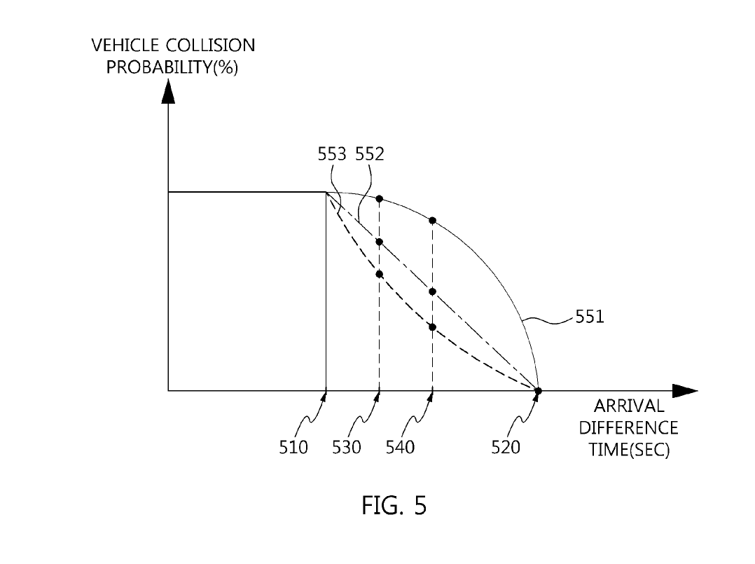

FIG. 5 is a diagram illustrating an example of a collision probability function according to the present invention.

Referring to FIG. 5, the collision probability function according to the present invention is a function in which arrival difference time, that is, the absolute value of the difference between the arrival time of the first vehicle 401 to each predicted collision point and the arrival time of the second vehicle 405 to the predicted collision point, is a function variable and the vehicle collision probability corresponding to the arrival difference time is a function result value.

In this case, the collision probability function may be adjusted in various ways in order to more accurately predict the vehicle collision probability based on the arrival difference time.

For example, the collision probability function may be a function in which the vehicle collision probability is 100% in the range from an arrival difference time of 0 to a first difference time 510, the vehicle collision probability gradually decreases in the range from the first difference time 510 to a second difference time 520, and the vehicle collision probability is 0% in the range from the second difference time 520.

In this case, the collision probability function in the range from the first difference time 510 to the second difference time 520 may be a function 551 to 553 in which a third vehicle collision probability in the case where the arrival difference time is the third difference time 530 is equal to or higher than a fourth vehicle collision probability in the case where the arrival difference time is a fourth difference time 540 that is longer than the third difference time 530.

In this case, the collision probability function may be a function that is set by taking into consideration one or more of the type of vehicle, the speed of a vehicle, and the number of lanes.

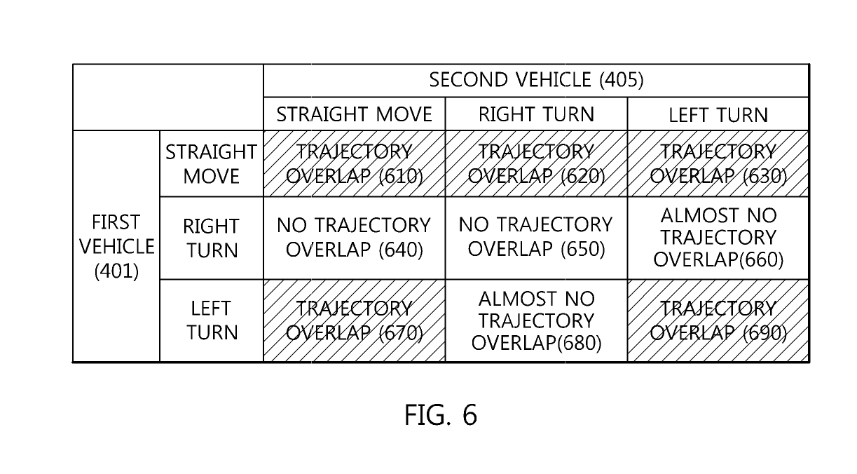

FIG. 6 is a diagram illustrating an example of a collision matrix according to the present invention.

Referring to FIG. 6, it can be seen that the collision matrix according to the present invention is a matrix indicating whether there is a trajectory overlap between the vehicle trajectories of a first vehicle 401 that enters a first access road and the vehicle trajectories of a second vehicle 405 that enters a second access road.

For example, the collision matrix may be a collision matrix indicating that when, at a four-way intersection, the access road of the first vehicle 401 is oriented in a southward direction and the access road of the second vehicle 405 is oriented in an eastward direction, there is a trajectory overlap (610) in the case where the first vehicle 401 travels straight ahead and the second vehicle 405 travels straight ahead, there is a trajectory overlap (602) in the case where the first vehicle 401 travels straight ahead and the second vehicle 405 turns right, there is a trajectory overlap (630) in the case where the first vehicle 401 travels straight ahead and the second vehicle 405 turns left, there is no trajectory overlap (640) in the case where the first vehicle 401 turns right and the second vehicle 405 travels straight ahead, there is no trajectory overlap (650) in the case where the first vehicle 401 turns right and the second vehicle 405 turns right, there is almost no trajectory overlap (660) in the case where the first vehicle 401 turns right and the second vehicle 405 turns left, there is a trajectory overlap (670) in the case where the first vehicle 401 turns left and the second vehicle 405 travels straight ahead, there is almost no trajectory overlap (680) in the case where the first vehicle 401 turns left and the second vehicle 405 turns right, and there is a trajectory overlap (690) in the case where the first vehicle 401 turns left and the second vehicle 405 turns left.

In this case, the collision matrix may include a number of matrices equal to the number of access roads.

For example, if the number of access roads is 3, the collision matrix may include a first matrix indicating whether there is a trajectory overlap between the vehicle trajectories of a first vehicle 401 that enters a first access road and the vehicle trajectories of a second vehicle 405 that enters a second access road, a second matrix indicating whether there is a trajectory overlap between the vehicle trajectories of the first vehicle 401 that enters the first access road and the vehicle trajectories of a third vehicle that enters a third access road, and a third matrix indicating whether there is a trajectory overlap between the vehicle trajectories of the second vehicle 405 that enters the second access road and the vehicle trajectories of the third vehicle that enters the third access road.

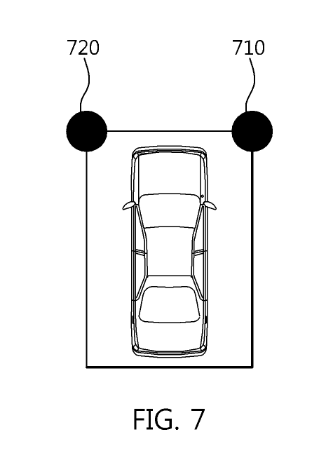

FIG. 7 is a diagram illustrating an example of vehicle heading information according to the present invention.

Referring to FIG. 7, the vehicle heading information according to the present invention may include right heading coordinates 710 and left heading coordinates 720 that belong to the corner coordinates of the vehicle and that are two sets of coordinate values in the heading direction of the vehicle.

In this case, the turning probability calculation unit 210 may calculate a vehicle turning direction using the time rate of change in the right heading coordinates 710 and the time rate of change in the left heading coordinates 720, and may calculate the vehicle turning probability using the vehicle turning direction and the vehicle turning frequency information.

In this case, the turning probability calculation unit 210 may determine that the vehicle turning direction corresponds to a straight move if the rate of change in turning difference, that is, the difference between the time rate of change in the right heading coordinates 710 and the time rate of change in the left heading coordinates 720 is lower than a preset reference straight moving value.

In this case, the turning probability calculation unit 210 may determine that the vehicle turning direction corresponds to a right turn if the rate of change in turning difference is equal to or higher than the preset reference straight moving value and the time rate of change in the right heading coordinates 710 is larger than the time rate of change in the left heading coordinates 720.

In this case, the turning probability calculation unit 210 may determine that the vehicle turning direction corresponds to a left turn if the rate of change in turning difference is equal to or higher than the preset reference straight moving value and the time rate of change in the left heading coordinates 720 is higher than the time rate of change in the right heading coordinates 710.

In this case, the vehicle turning probability may include a straight move probability, a right turn probability, and a left turn probability.

In this case, the straight move probability may be a vehicle turning probability that is calculated such that a first straight move probability in the case where the rate of change in turning difference, that is, the difference between the time rate of change in the right heading coordinates 710 and the time rate of change in the left heading coordinates 720, is the first rate of change in turning difference, is lower than a second straight move probability in the case where the rate of change in turning difference is the second rate of change in turning difference that is lower than the first rate of change in turning difference.

In this case, the right turn probability may be a vehicle turning probability that is calculated such that when the time rate of change in the right heading coordinates 710 is higher than the time rate of change in the left heading coordinates 720, a first right turn probability in the case where the rate of change in turning difference is the first rate of change in turning difference is higher than a second right turn probability in the case where the rate of change in turning difference is the second rate of change in turning difference that is lower than the first rate of change in turning difference.

In this case, the right turn probability may be a vehicle turning probability that is calculated such that when the time rate of change in the left heading coordinates 720 is higher than the time rate of change in the right heading coordinates 710, a first right turn probability in the case where the rate of change in turning difference is the first rate of change in turning difference is a second right turn probability in the case where the rate of change in turning difference is the second rate of change in turning difference that is lower than the first rate of change in turning difference.

In this case, the left turn probability may be a vehicle turning probability that is calculated such that when the time rate of change in the left heading coordinates 720 is higher than the time rate of change in the right heading coordinates 710, a first left turn probability in the case where the rate of change in turning difference is the first rate of change in turning difference is higher than a second left turn probability in the case where the rate of change in turning difference is the second rate of change in turning difference that is lower than the first rate of change in turning difference.

In this case, the left turn probability may be a vehicle turning probability that is calculated such that when the time rate of change in the right heading coordinates 710 is higher than the time rate of change in the left heading coordinates 720, a first left turn probability in the case where the rate of change in turning difference is the first rate of change in turning difference is a second left turn probability in the case where the rate of change in turning difference is the second rate of change in turning difference that is lower than the first rate of change in turning difference.

Although not illustrated in FIG. 7, the turning probability calculation unit 210 may calculate the vehicle turning probability using any one of a Markov chain technique and a Bayesian technique.

In accordance with the present invention, there is provided an apparatus and method for providing intersection collision-related information, which acquire intersection traffic information using a road sensor provided at an intersection and a vehicle sensor provided in a vehicle, calculate intersection collision-related information using the intersection traffic information, and provide the intersection collision-related information to a user, thereby enabling the provision of intersection collision-related information that is capable of allowing a user to pass through the intersection more safely.

Furthermore, in accordance with the present invention, there is provided an apparatus and method for providing intersection collision-related information, which probabilistically calculate a vehicle turning direction using vehicle heading information and vehicle turning frequency information in advance before a vehicle turns at an intersection, calculate intersection collision-related information using the vehicle turning direction, and provide the intersection collision-related information, thereby enabling the provision of intersection collision-related information that is capable of allowing a user to become aware of the degree of risk in advance before the user passes through the intersection.

Furthermore, in accordance with the present invention, there is provided an apparatus and method for providing intersection collision-related information, which select predicted collision points using contacts between vehicle trajectories, determine whether each of the predicted collision points is a highly risky point, and provide the results of the determination to a user, thereby enabling the provision of intersection collision-related information that is capable of allowing a user to become clearly aware of points to which the user should pay attention while passing through the intersection.

Moreover, in accordance with the present invention, there is provided an apparatus and method for providing intersection collision-related information, which calculate a vehicle collision probability using a collision probability function, thereby enabling the provision of intersection collision-related information that is capable of allowing a user to become more clearly aware of the degree of risk while passing through the intersection.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing intersection collision-related information, comprising:
a surrounding information acquisition unit configured to acquire intersection traffic information including vehicle heading information, vehicle turning frequency information, vehicle trajectory information and vehicle speed information from one or more of a road sensor provided at an intersection and a vehicle sensor provided in a vehicle;
a collision-related information calculation unit configured to calculate intersection collision-related information including a degree of vehicle collision risk that is calculated using the intersection traffic information; and
a collision-related information provision unit configured to provide the calculated intersection collision-related information to a user.

2. The apparatus of claim 1, wherein the collision-related information calculation unit comprises:
a turning probability calculation unit configured to calculate a vehicle turning probability using the vehicle heading information and the vehicle turning frequency information;
a collision probability calculation unit configured to calculate a vehicle collision probability using the vehicle trajectory and the vehicle speed information; and
a degree-of-collision risk calculation unit configured to calculate the degree of vehicle collision risk using the vehicle turning probability and the vehicle collision probability.

3. The apparatus of claim 2, wherein the collision probability calculation unit selects predicted collision points using contacts between vehicle trajectories, calculates arrival time to each of the predicted collision points using the vehicle speed information, and calculates the vehicle collision probability using the arrival time and a collision probability function.

4. The apparatus of claim 3, wherein the collision probability function is a function in which arrival difference time, that is, an absolute value of the difference between the arrival time of the first vehicle to each of the predicted collision points and the arrival time of the second vehicle to the predicted collision point, is a function variable and the vehicle collision probability corresponding to the arrival difference time is a function result value.

5. The apparatus of claim 4, wherein the degree-of-collision risk calculation unit calculates a value obtained by adding products of the vehicle turning probability and the vehicle collision probability at the predicted collision points as the degree of vehicle collision risk.

6. The apparatus of claim 4, wherein the vehicle heading information is right heading coordinates and left heading coordinates that belong to the corner coordinates of the vehicle and that are two sets of coordinate values in a heading direction of the vehicle.

7. The apparatus of claim 6, wherein the turning probability calculation unit calculates a vehicle turning direction using time rates of change of the right heading coordinates and the left heading coordinate, and calculates the vehicle turning probability using the vehicle turning direction and the vehicle turning frequency information.

8. The apparatus of claim 4, wherein the vehicle trajectory information is information about a trajectory that is set by taking into consideration one or more of a number of access roads to the intersection, and a number of lanes and a breadth of lanes for each access road.

9. The apparatus of claim 4, wherein the collision-related information provision unit provides the intersection collision-related information corresponding to a vehicle in which the user rides in real time

10. The apparatus of claim 4, wherein the collision-related information provision unit provides highly risky point information and highly risky time span information at the intersection using the intersection collision-related information corresponding to each of the vehicles that enter the intersection.

11. A method of providing intersection collision-related information, comprising:
acquiring intersection traffic information including vehicle heading information, vehicle turning frequency information, vehicle trajectory information and vehicle speed information from one or more of a road sensor provided at an intersection and a vehicle sensor provided in a vehicle;
calculating intersection collision-related information including a degree of vehicle collision risk that is calculated using the intersection traffic information; and
providing the calculated intersection collision-related information to a user.

12. The method of claim 11, wherein calculating the intersection collision-related information comprises:
calculating a vehicle turning probability using the vehicle heading information and the vehicle turning frequency information;
calculating a vehicle collision probability using the vehicle trajectory and the vehicle speed information; and
calculating the degree of vehicle collision risk using the vehicle turning probability and the vehicle collision probability.

13. The method of claim 12, wherein calculating the intersection collision-related information comprises:
selecting predicted collision points using contacts between vehicle trajectories;
calculating arrival time to each of the predicted collision points using the vehicle speed information; and
calculating the vehicle collision probability using the arrival time and a collision probability function.

14. The method of claim 13, wherein the collision probability function is a function in which arrival difference time, that is, an absolute value of the difference between the arrival time of the first vehicle to each of the predicted collision points and the arrival time of the second vehicle to the predicted collision point, is a function variable and the vehicle collision probability corresponding to the arrival difference time is a function result value.

15. The method of claim 14, wherein calculating the degree of vehicle collision risk comprises calculating a value obtained by adding products of the vehicle turning probability and the vehicle collision probability at the predicted collision points as the degree of vehicle collision risk.

16. The method of claim 14, wherein the vehicle heading information is right heading coordinates and left heading coordinates that belong to the corner coordinates of the vehicle and that are two sets of coordinate values in a heading direction of the vehicle.

17. The method of claim 16, wherein calculating the vehicle turning probability comprises calculating a vehicle turning direction using time rates of change of the right heading coordinates and the left heading coordinate, and calculating the vehicle turning probability using the vehicle turning direction and the vehicle turning frequency information.

18. The method of claim 14, wherein the vehicle trajectory information is information about a trajectory that is set by taking into consideration one or more of a number of access roads to the intersection, and a number of lanes and a breadth of lanes for each access road.

19. The method of claim 14, wherein providing the calculated intersection collision-related information comprises providing the intersection collision-related information corresponding to a vehicle in which the user rides in real time

20. The method of claim 14, wherein providing the calculated intersection collision-related information comprises providing highly risky point information and highly risky time span information at the intersection using the intersection collision-related information corresponding to each of the vehicles that enter the intersection.
